(19) United States
(12) Patent Application Publication
(10) Pub. No.: US 2026/0194377 A1
(43) Pub. Date: Jul. 9, 2026

(54) SECURING DEVICE FOR ULTRASONIC MEASURING DEVICE

(71) Applicant: Endress+Hauser Flowtec AG, Reinach (CH)

(72) Inventors: Andreas Berger, Erschwil (CH); Roberto Vitali, Therwil (CH); Beat Kissling, Reinach (CH); Thomas Jahn, Möhlin (CH); Sascha Grunwald, Steinen (DE); Quirin Müller, Bättwil (CH)

(21) Appl. No.: 19/131,156

(22) PCT Filed: Oct. 25, 2023
(86) PCT No.: PCT/EP2023/079797

§ 371 Date: May 19, 2025

(30) Foreign Application Priority Data
Nov. 18, 2022 (DE) 10 2022 130 628.3

(51) Int. Cl. G01F 1/66

(52) U.S. Cl. CPC G01F 1/662

(57) ABSTRACT

A securing device designed to secure at least one clamp-on ultrasonic transducer of an ultrasonic measuring device on a conduit conveying media, includes: a main body configured to be placed on a support device of a clamp-on ultrasonic transducer of the at least one clamp-on ultrasonic transducer(s); a tensioning device for exerting a tensile force on the conduit; and at least one tensioning element, such as a chain or a belt, which is configured to transmit the tensile force, and which has two ends, wherein the securing device has a rocker device designed to compensate in the installed state for tilting moments exerted on the support device.
A securing device designed to secure at least one clamp-on ultrasonic transducer of an ultrasonic measuring device on a conduit conveying media, includes: a main body configured to be placed on a support device of a clamp-on ultrasonic transducer of the at least one clamp-on ultrasonic transducer(s); and a tensioning device for exerting a tensile force on the conduit; at least one tensioning element, such as a chain or a belt, which is configured to transmit the tensile force, and which has two ends, wherein the securing device has a rocker device designed to compensate in the installed state for tilting moments exerted on the support device.

The invention relates to a securing device for securing a clamp-on ultrasonic transducer to a conduit and relates to a clamp-on ultrasonic transducer and an ultrasonic measuring device.

Clamp-on ultrasonic measuring devices, such as those disclosed in DE102016119910A1, have ultrasonic transducers that are secured to the outside of conduits conveying media. Typically, securing straps or securing belts are used to attach such ultrasonic transducers. However, this can lead to displacement of the ultrasonic transducer when securing.

The object of the invention is therefore to propose a securing device, a clamp-on ultrasonic transducer, and an ultrasonic measuring device such that a clamp-on ultrasonic transducer can be secured precisely, reliably, and robustly.

The object is achieved by a securing device according to independent claim 1, by an ultrasonic transducer according to independent claim 8, and by an ultrasonic measuring device according to independent claim 9.

A securing device according to the invention designed for securing at least one clamp-on ultrasonic transducer of an ultrasonic measuring device to a conduit conveying media comprises:
a main body configured to be placed on a support device of a clamp-on ultrasonic transducer of the at least one clamp-on ultrasonic transducer;
a tensioning device for exerting a tensile force on the conduit;
at least one tensioning element, such as a chain or a belt, which is configured to transmit the tensile force, and which has two ends;
wherein the securing device has a rocker device which is designed to compensate, in the installed state, for tilting moments exerted on the support device.

In one embodiment, the rocker device has a rocker with two ends and a central region, the rocker being mounted in the central region on the main body in a manner allowing rotation by means of a rotary bearing of the main body,
wherein, in the installed state, each end of a tensioning element is secured to one end of the rocker, or wherein the at least one tensioning element runs partially along the rocker and the ends of the rocker deflect at least one of the at least one tensioning element(s).

In one embodiment, the securing device has two tensioning elements and a counter arm of the rocker device, wherein the main body, the tensioning elements and the counter arm are designed to engage around the conduit, wherein the counter arm is designed to be mounted on the conduit in a manner allowing movement in a plane which passes through a conduit cross-section, wherein the counter arm is mechanically connected to the main body by means of the two tensioning elements,
wherein the tensioning device is designed to work counter to a counter arm placed on the conduit.

In one embodiment, the tensile force can be generated via at least one of the two ends of the tensioning device, for example by means of a screw device,
or the ends each overlap one of the at least one tensioning element(s), wherein the tensile force can be adjusted by means of the tensioning device, for example by means of a screw device, by modifying the overlap.

In one embodiment, the tensioning device is designed to produce a contact force of 1000 Newtons.

In one embodiment, the rocker and the main body are each made of a metal such as aluminum or steel.

In one embodiment, the tensioning element is made of a metal such as aluminum or steel.

A clamp-on ultrasonic transducer according to the invention comprises:
an ultrasonic transducer element for generating and detecting ultrasonic signals;
a coupling body for transmitting ultrasonic signals between the ultrasonic transducer and the conduit;
a support device for supporting the securing device according to any of the preceding claims, wherein the support device is designed to work directly or indirectly counter to the coupling body.

An ultrasonic measuring device according to the invention comprises:
at least one clamp-on ultrasonic transducer for measuring a parameter such as sound velocity or flow velocity of a medium, secured with a securing device according to any of the preceding claims to a conduit conveying media;
an electronic measuring/operating circuit for operating the at least one ultrasonic transducer, for capturing and evaluating measurement signals from the at least one ultrasonic transducer, and for providing measured values of a parameter,
wherein the conduit has a conduit diameter,
wherein the rocker has an extension measuring at least one conduit diameter in a cross-sectional plane through the conduit.

The invention will be described in the following with reference to embodiments.

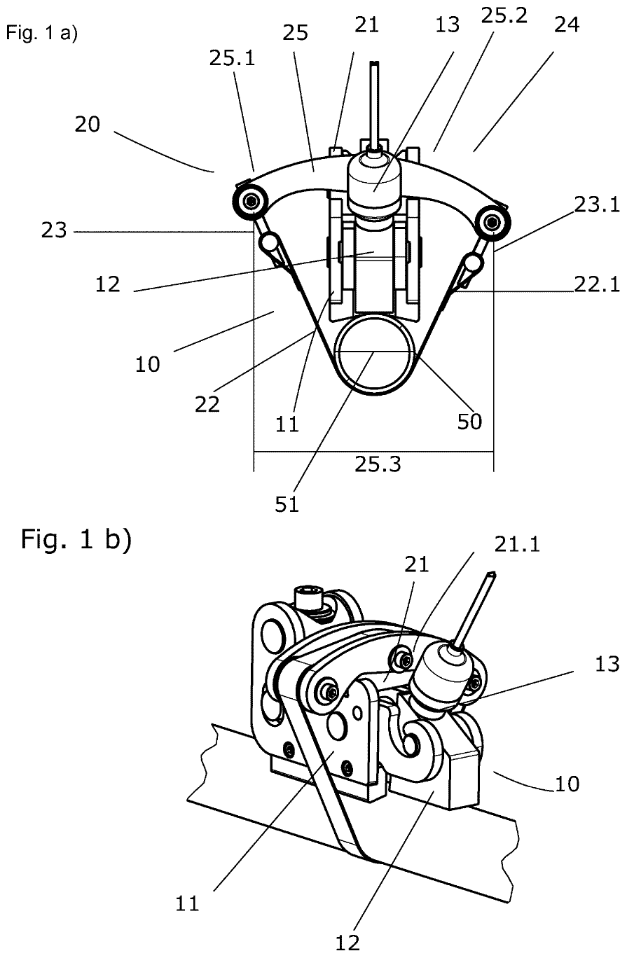

FIG. 1 a) and b) show an exemplary embodiment of the securing device according to the invention;

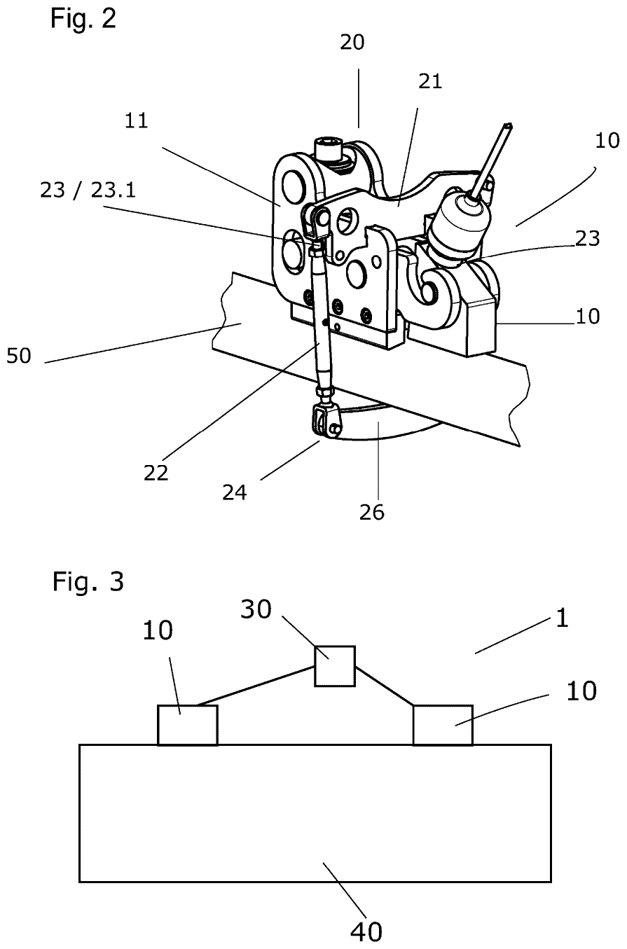

FIG. 2 shows an exemplary embodiment of the securing device according to the invention.

FIG. 3 shows an exemplary embodiment of an ultrasonic measuring device with clamp-on ultrasonic transducers.

FIG. 1 a) shows a front view and FIG. 1 b) shows an oblique view of an exemplary securing device 20 according to the invention in the installed state on a conduit 50, which presses a support device 11 of an exemplary clamp-on ultrasonic transducer according to the invention in the direction of the conduit. For this purpose, a tensile stress is exerted against the conduit via at least one tensioning element 22. According to the invention, the securing device 20 has a rocker device 24, which, as shown here, can have a rocker 25 with two ends 25.1 and a central region 25.2. The rocker 25 is rotatably mounted on a main body 21 of the securing device 20 by means of a rotary bearing 21.1. Due to its rotational mobility, the rocker can reduce the generation of tilting forces and tilting moments, so that a force exerted on the ultrasonic transducer is substantially normal to a surface of the conduit.

As shown here, a tensioning element 22 can be intended to engage around the conduit. As shown here, in this case, each end 22.1 of the tensioning element can be secured to one end 25.1 of the rocker, wherein at least one end of the rocker is provided with a tensioning device 23 for generating a tensile stress in a tensioning element. This can be achieved, for example, using a screw device 23.1. If two tensioning devices are used per tensioning element as shown here, tilting of the ultrasonic transducer can be prevented in an improved manner.

In one embodiment, an extension 25.3 of the rocker in a cross-sectional plane through the conduit is at least one conduit diameter 51. This prevents tilting of the ultrasonic transducer in an improved manner.

A clamp-on ultrasonic transducer 10 has a support device 11 for supporting a securing device and for holding a coupling body 12 of the clamp-on ultrasonic transducer, wherein an ultrasonic transducer element 13 for generating and detecting ultrasonic signals is arranged on the coupling body.

FIG. 2 shows an oblique view of an exemplary securing device 20 according to the invention in the installed state on a conduit 50, which presses a support device 11 of an exemplary clamp-on ultrasonic transducer according to the invention in the direction of the conduit. For this purpose, a tensile stress is exerted against the conduit via a counter arm 26 via at least two tensioning elements 22, with the two tensioning elements each acting on one end of the counter arm. The main body 21, the tensioning elements and the counter arm engage around the conduit 50 in the installed state, wherein the counter arm is designed to be mounted on the conduit in a manner allowing movement in a plane through a conduit cross section. In this way, it is able to rock to counteract tilting moments. The counter arm thus forms a rocker device according to the invention, by way of example.

FIG. 3 outlines an exemplary schematic clamp-on ultrasonic measuring device 1 with two clamp-on ultrasonic transducers 10, which are arranged on an outer side of the conduit 50. An electronic measuring/operating circuit 30 is configured to operate the at least one clamp-on ultrasonic transducer, to evaluate measurement signals of the at least one clamp-on ultrasonic transducer, and to provide measured values of a parameter. Such a parameter can be, for example, a flow velocity or a sound velocity of a medium flowing through the conduit. For example, a method based on travel time or travel time differences can be used. The number of clamp-on ultrasonic transducers shown here and their arrangement are purely exemplary and not limiting. The ultrasonic transducers can each be secured with a securing device according to the invention.

### LIST OF REFERENCE SIGNS

1 Ultrasonic measuring device
10 Clamp-on ultrasonic transducer
11 Support device
12 Coupling body
13 Ultrasonic transducer
20 Securing device
21 Main body
21.1 Rotary bearing
22 Clamping element
22.1 End of the tensioning element
23 Tensioning device
23.1 Screw device
24 Rocker device
25 Rocker
25.1 End of the rocker
25.2 Central region of the rocker
25.3 Extension of the rocker
26 Counter arm
30 Electronic measuring/operating circuit
50 Pipeline
51 Conduit diameter

1-9. (canceled)

10. A securing device configured for securing at least one clamp-on ultrasonic transducer of an ultrasonic measuring device to a conduit conveying media, the securing device comprising:
a main body configured to be placed on a support device of a clamp-on ultrasonic transducer of the at least one clamp-on ultrasonic transducer;
a tensioning device adapted to exert a tensile force on the conduit;
at least one tensioning element configured to transmit the tensile force, each tensioning element having two ends; and
a rocker device embodied to at least partially prevent tilting forces and tilting moments exerted on the support device.

11. The securing device according to claim 10, wherein the rocker device includes a rocker with two ends and a central region, the rocker being mounted in the central region on the main body in a manner allowing rotation via a rotary bearing of the main body,
wherein, in an installed state, each end of the at least one tensioning element is secured to one end of the rocker, or wherein the at least one tensioning element runs partially along the rocker and the ends of the rocker deflect at least one tensioning element of the at least one tensioning element.

12. The securing device according to claim 10, wherein the securing device includes two tensioning elements and a counter arm of the rocker device,
wherein the main body, the tensioning elements, and the counter arm are configured to engage around the conduit,
wherein the counter arm is configured to be mounted on the conduit in a manner allowing movement in a plane which passes through a conduit cross-section, wherein the counter arm is mechanically connected to the main body via the two tensioning elements, and
wherein the tensioning device is configured to work counter to the counter arm placed on the conduit.

13. The securing device according to claim 11, wherein the tensile force can be generated via at least one of the two ends of the tensioning device, or
wherein the ends of the tensioning device each overlap one end of the at least one tensioning element, wherein the tensile force can be adjusted by means of the tensioning device by modifying the overlap.

14. The securing device according to claim 13, wherein the tensile force can be generated and/or adjusted via a screw device.

15. The securing device according to claim 10, wherein the tensioning device is operable to produce a contact force of 1000 Newtons.

16. The securing device according to claim 11, wherein the rocker and the main body are each made of aluminum or steel.

17. The securing device according to claim 10, wherein the at least one tensioning element is made of aluminum or steel.

18. The securing device according to claim 10, wherein the at least one tensioning element is a chain or a belt.

19. A clamp-on ultrasonic transducer, comprising:
an ultrasonic transducer element configured to generate and detect ultrasonic signals;
a coupling body configured to transmit ultrasonic signals between the ultrasonic transducer and the conduit; and
a support device configured to support the securing device according to claim 10, wherein the support device is adapted to act directly or indirectly against the coupling body.

20. An ultrasonic measuring device, comprising:
at least one clamp-on ultrasonic transducer configured to measure a parameter of a medium and to be secured to a conduit conveying the medium with a securing device according to claim 10; and
an electronic measuring/operating circuit configured to operate the at least one ultrasonic transducer, to capture and evaluate measurement signals from the at least one ultrasonic transducer, and to provide measured values of the parameter,
wherein the conduit has a conduit diameter, and
wherein the rocker extends at least one conduit diameter in a cross-sectional plane through the conduit.

21. The ultrasonic measuring device, wherein the parameter is a sound velocity or a flow velocity of a medium in the conduit.
